(19) United States
(12) Patent Application Publication
(10) Pub. No.: US 2012/0317739 A1
(43) Pub. Date: Dec. 20, 2012

(54) WINDSHIELD WIPER DEVICE

(75) Inventor: Juergen Rapp, Lauf (DE)

(73) Assignee: ROBERT BOSCH GMBH, Stuttgart (DE)

(21) Appl. No.: 13/516,951

(22) PCT Filed: Oct. 26, 2010
(86) PCT No.: PCT/EP2010/066100

§ 371 Date: Sep. 4, 2012

(30) Foreign Application Priority Data
Dec. 17, 2009 (DE) 10 2009 054 830.0

(51) Int. Cl. B60S 1/04

(52) U.S. Cl. 15/250.001

(57) ABSTRACT

The invention relates to a windshield wiper device (100) comprising a wiper shaft bearing (110) for mounting a wiper shaft (140), wherein the wiper shaft bearing (110) has a first axial section (210) and a second axial section (220) connected to the first in a force-fit manner, and the first axial section (210) is designed to be telescopically inserted into the second axial section (220).

### BACKGROUND OF THE INVENTION

Customary windshield wiper devices, as used in motor vehicles, comprise wiper arms which are moved in oscillating manner in a circular segment about a wiper shaft. The wiper shaft and a tubular bearing for receiving the wiper shaft extend in a direction running substantially perpendicularly to a surface of a window of the motor vehicle. In the event of the motor vehicle colliding with a person outside the motor vehicle, there is the risk of the person striking, for example with the head, axially on the wiper shaft and on the bearing and suffering severe injuries.

### SUMMARY OF THE INVENTION

It is the object of the invention to indicate a windshield wiper device for a motor vehicle, which minimizes a risk of injury by means of the windshield wiper device to a person impacting against the motor vehicle.

EP 1 939 055 A2 shows a windshield wiper device with a drive and two wiper shaft bearings which are fixed to the drive by means of tubular plates.

According to the invention, a windshield wiper device for a motor vehicle has a wiper shaft bearing for the mounting of a wiper shaft, wherein the wiper shaft bearing has a first axial section and a second axial section connected to the first axial section in a frictional manner, and the first axial section is designed to be telescopically inserted into the second axial section.

In the event of an impact of a person against the windshield wiper device, the first section can advantageously only exert small axial forces on the person, thus minimizing a risk of injury by means of the windshield wiper device to the person. Furthermore advantageously, the wiper shaft bearing can be dimensioned in such a manner that, prior to the impact, the wiper shaft is in an optimized position for the articulation of wiper blades and, during or after the impact, adopts a position which minimizes the risk of injury to a person.

A transition section with a predetermined breaking point for severing the frictional connection between the two axial sections in the event of overloading can be provided in a region between the first and the second axial section of the wiper shaft bearing. The effect which can advantageously be achieved by the predetermined breaking point is that, after an impact-induced overcoming of the breaking force which is required for releasing the predetermined breaking point, a telescopic movement of the first axial section into the second axial section requires only comparatively small forces. At the same time, if the predetermined breaking point is intact prior to the impact, forces can be simply, precisely and cost-effectively transmitted in the wiping mode of the windshield wiper device.

The first axial section, the second axial section and the transition section can be connected to one another in a cohesively bonded manner and, in particular, integrally. This permits cost-effective production of the wiper shaft bearing and in particular an integrated formation of the predetermined breaking point with a defined breaking force between the first and the second axial section of the wiper shaft bearing.

The first axial section can have a circular-cylindrical shape and the second axial section can have a hollow-cylindrical shape. As a result, during the telescopic displacement of the first axial section into the second axial section, a risk of the two axial sections becoming wedged can be minimized. Furthermore, the predetermined breaking point can be formed in a circular manner such that an axially symmetrical distribution of the breaking force of the predetermined breaking point can be obtained. The risk of injury to the impacting person can therefore be minimized irrespective of an impact direction of the person.

An outside diameter of the first axial section may be larger than an inside diameter of the second axial section. As a result, after being pushed into the second axial section, the first axial section may also adopt a tilted position, and therefore the first axial section and the parts connected thereto can be displaced in the tilting direction by the impacting person, thus enabling the risk of injury to the person to be lowered further.

The second axial section may have a fastening element for the fastening of the wiper shaft bearing. In particular, the fastening element may comprise a plug-in element for connection to a tubular plate of the windshield wiper device. An integrated wiper shaft bearing for a windshield wiper device can therefore be produced in a simple and cost-effective manner, wherein the wiper shaft bearing can differ only little, if at all, from a known wiper shaft bearing. In particular, the wiper shaft bearing can be designed to be produced as an injection molded component suitable for mass manufacturing.

### BRIEF DESCRIPTION OF THE DRAWINGS

The invention is described in more detail below with reference to the attached drawings, in which:

FIG. 1 shows a windshield wiper device;

FIG. 2 shows the wiper shaft bearing of the windshield wiper device from FIG. 1;

FIG. 3 shows a longitudinal section of the wiper shaft bearing from FIGS. 1 and 2; and

FIG. 4 shows a detail of the longitudinal section from FIG. 3.

### DETAILED DESCRIPTION

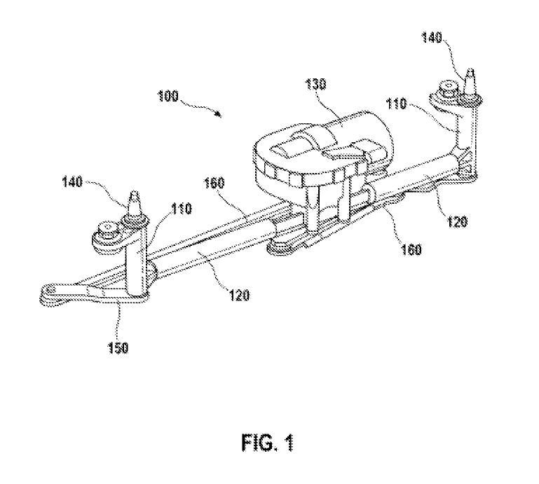

FIG. 1 shows a windshield wiper device 100 for use in a motor vehicle. The windshield wiper device 100 comprises two wiper shaft bearings 110, which are also called shaped tubes, and two tubular plates 120, by means of which the wiper shaft bearings 110 are fixed to a drive 130 of the windshield wiper device 100. A wiper shaft 140 runs through each of the wiper shaft bearings 110, the upper end of which wiper shaft is designed for the fastening of a wiper arm to a wiper blade (not shown). A wiper crank 150, which can be driven by the drive 130 by means of a connecting rod 160, is fastened in a torque-locking manner to the lower end of each wiper shaft 140. In an alternative embodiment, the wiper crank 150 can also be arranged at the upper end of the wiper shaft 140. In a further embodiment, the windshield wiper device 100 comprises fewer or more wiper shaft bearings 140, for example one or three.

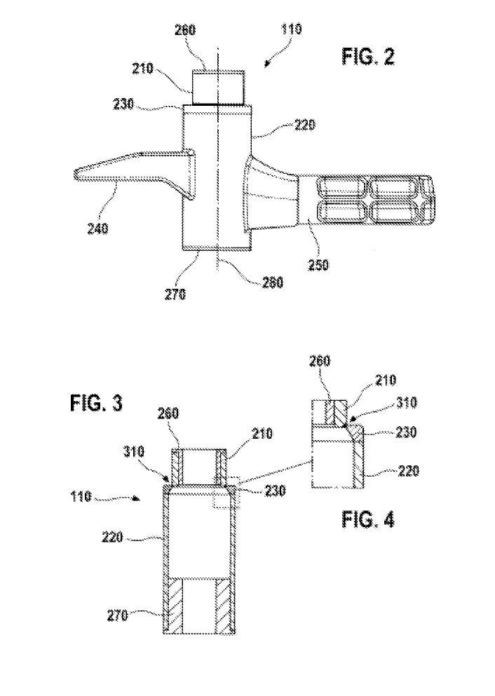

FIG. 2 shows the wiper shaft bearing 110 of the windshield wiper device 100 from FIG. 1 in a lateral view. The wiper shaft bearing 110 comprises a first axial section 210 and a second axial section 220, which are connected to each other in a frictional manner by means of a transition section 230. A fastening link 240 and a fastening plug-in element 250 extend in radial directions from the second axial section 220. The fastening link 240 is designed for fastening the windshield wiper device 100, for example, to a motor vehicle body. The fastening plug-in element 250 tapers out in a pin-shaped manner and is designed for pushing into the tubular plate 120 from FIG. 1. A plurality of visible depressions in the fastening plug-in element 250 serve to save weight.

The first axial section 210 bears an upper bearing bush 260 at the upper end thereof; a lower bearing bush 270 is fitted at the lower end of the second axial section 220. The upper bearing bush 260 and the lower bearing bush 270 are designed for mounting the wiper shaft 140 from FIG. 1 about an axis of rotation 280.

In a preferred embodiment, the wiper shaft bearing 110 with the exception of the upper bearing bush 260 and the lower bearing bush 270 is completely produced by injection molding. The wiper shaft bearing 110 may be manufactured from plastic to which, for example, glass fibers can be added for reinforcement purposes.

The outside diameter of the first axial section 210 of the wiper shaft bearing 110 is selected in such a manner that the first axial section 210 can be telescopically pushed into the hollow-cylindrical second axial section 220 of the wiper shaft bearing 110. A height of the first axial section 210 along the axis of rotation 280 determines the length about which the wiper shaft bearing 110 can be shortened in the event of an impact.

If, for example, it is required for an axial distance of the windshield wiper device 100 from FIG. 1 from an engine hood located thereabove to be at least 85 mm in order to minimize the risk of injury while, for operation of the windshield wiper device 100, an optimum distance from the engine hood is only 10 mm, the axial height of the first axial section 210 of the wiper shaft bearing 110 can be, for example, 75 mm so that, in the event of an impact, telescopic pushing of the first axial section 210 into the second axial section 220 of the wiper shaft bearing 110 can reduce the entire overall height of the windshield wiper device 100 in such a manner that the required distance of the windshield wiper device 100 from the original position of the engine hood of 85 mm is maintained.

FIG. 3 shows a longitudinal section through the wiper shaft bearing 110 from FIGS. 1 and 2. The longitudinal section illustrated is selected such that the fastening link 240 and the fastening plug-in element 250 from FIG. 2 are not visible.

The lower bearing bush 270 has a collar at the lower end thereof such that said bearing bush cannot be introduced further than up to said collar into the second axial section 220. The lower bearing bush 270 is preferably fastened to the second axial section 220 by a press or clamping fit; alternatively or in addition, the lower bearing bush 270 may also be, for example, adhesively bonded in, soldered in or shrunk in. The same applies to the upper bearing bush 260, with the difference that the upper bearing bush 260 is introduced into the first axial section 210 from above and bears a collar at the upper end thereof in order to limit the introduction.

The upper bearing bush 260 minus the collar described is as high as the first axial section 210. A shorter upper bearing bush 260 has a smaller connecting surface with respect to the first axial section 210 and is therefore not advantageous; by contrast, a longer upper bearing bush 260 does not bring about an enlarged connecting surface with respect to the first axial section 210 and is therefore generally unnecessary.

The lower bearing bush 270 is only of a height such that a remaining space between the upper end of the lower bearing bush 270 and the upper end of the second axial section 220 is sufficient in order to receive the second axial section 220 over the entire length thereof.

A predetermined breaking point 310, which encircles the first axial section 210 annularly, is located in the transition section 230, which connects the first axial section 210 to the second axial section 220.

The upper bearing bush 260 and the lower bearing bush 270 have the same inside diameter for guiding the wiper shaft 140 from FIG. 1. Elements fitted to the upper ends of the wiper shaft 140 from FIG. 1, for example a wiper arm with a wiper blade, owing to the radial expansion thereof, prevent the wiper shaft 140 from being displaced downward in the upper bearing bush 260. An axial loading of the wiper shaft 140 downward is therefore transmitted to the upper bearing bush 260 and the first axial section 210. The predetermined breaking point 310 in the transition section 230 is released when the predetermined breaking force thereof is exceeded, and the first axial section 210 is telescopically pushed into the second axial section 220. At the same time, the wiper shaft 140 slides downward in the lower bearing bush 270.

The outside diameter of the first axial section 210 is selected to be significantly smaller than the inside diameter of the second axial section 220. The first axial section 210, which is pushed into the second axial section 220, therefore has a certain degree of freedom of movement in the radial direction, by means of which clamping or wedging of the first axial section 210 pushed into the second axial section 220 can be avoided.

FIG. 4 shows a detail of the longitudinal section of the wiper shaft bearing 110 from FIG. 3. FIG. 4 shows in particular the position of the predetermined breaking point 310 with respect to the first axial section 210, the second axial section 220 and the transition section 230 of the wiper shaft bearing 110. The transition section 230 has a cylindrical shape on the outside and it is in the shape of a hollow cone on the inside, and therefore the visible cross section of the transition section 230 is substantially in the shape of a trapezoid. The lower, shorter base side of the trapezoid is adjacent to the second axial section 220 in the axial direction of the wiper shaft bearing 110. In this region, the transition section 230 and the second axial section 220 have identical wall thicknesses. In a preferred embodiment, the transition section 230 is formed integrally with the second axial section 220. In alternative embodiments, the transition section 230 can be composed of the same material as or of a different material from the second axial section 220 and can be fastened to the second axial section 220, for example, by adhesive bonding, soldering or welding.

In the region of the upper, longer base line of the trapezoid, which region constitutes the cross section of the transition section 230, the transition section 230 is adjacent to the first axial section 210 in the radial direction. What has been stated above with regard to the second axial section 220 applies with regard to the pairing of materials and connection of the transition section 230 to the first axial section 210. In particular, the transition section 230 may be part of the first axial section 210 and/or of the second axial section 220.

The predetermined breaking point 310 runs annularly between the transition section 230 and the first axial section 210. If a force acting between the first axial section 210 and the second axial section 220 exceeds a magnitude which is predetermined by the shaping of the predetermined breaking point 310, the first axial section 210 is separated from the transition section 230 and the two axial sections 210, 220 of the wiper shaft bearing 210 are axially displaceable in relation to each other. The breaking force required for severing the predetermined breaking point 310 may comprise an axial component and optionally a radial component. Once the predetermined breaking point 310 has been opened, the wiper shaft bearing 110 of the wiper shaft 140 can generally no longer provide sufficient guidance and has to be replaced.

In alternative embodiments, the predetermined breaking point 310 may also be formed differently, in particular the predetermined breaking point 310 can be provided between the transition section 230 and the second axial section 220. Analogously to the embodiment illustrated in FIG. 4, the predetermined breaking point 310 can then be formed in the radial direction between the transition section 230 and the second axial section 220.

1. A windshield wiper device (100) for a motor vehicle, wherein the windshield wiper device (100) has a wiper shaft bearing (110) for the mounting of a wiper shaft (140), wherein the wiper shaft bearing (110) has a first axial section (210) and a second axial section (220) connected to the first axial section in a frictional manner, characterized in that the first axial section (210) is telescopically inserted into the second axial section (220).

2. The windshield wiper device (100) as claimed in claim 1, characterized in that a transition section (230) with a predetermined breaking point (310) for severing the frictional connection between the two axial sections (210, 220) in the event of overloading is provided in a region between the first and the second axial section (210, 220).

3. The windshield wiper device (100) as claimed in claim 1, characterized in that the first axial section (210), the second axial section (220) and the transition section (230) are connected to one another in a cohesively bonded manner.

4. The windshield wiper device (100) as claimed in claim 3, characterized in that the first axial section (210), the second axial section (220) and the transition section (230) are connected integrally to one another.

5. The windshield wiper device as claimed in claim 1, characterized in that the first axial section (210) has a circular-cylindrical shape and the second axial section (220) has a hollow-cylindrical shape.

6. The windshield wiper device (100) as claimed in claim 1, characterized in that an outside diameter of the first axial section (210) is larger than an inside diameter of the second axial section (220).

7. The windshield wiper device (100) as claimed in claim 1, characterized in that the second axial section (220) has a fastening element (240, 250) for the fastening of the wiper shaft bearing (110).

8. The windshield wiper device (100) as claimed in claim 7, characterized in that the fastening element comprises a plug-in element (250) for connection to a tubular plate (120) of the windshield wiper device (100).

9. The windshield wiper device (100) as claimed in claim 1, characterized in that the wiper shaft bearing (110) is produced as an injection molded component.

10. The windshield wiper device (100) as claimed in claim 2, characterized in that the first axial section (210), the second axial section (220) and the transition section (230) are connected to one another in a cohesively bonded manner.

11. The windshield wiper device (100) as claimed in claim 10, characterized in that the first axial section (210), the second axial section (220) and the transition section (230) are connected integrally to one another.

12. The windshield wiper device as claimed in claim 11, characterized in that the first axial section (210) has a circular-cylindrical shape and the second axial section (220) has a hollow-cylindrical shape.

13. The windshield wiper device (100) as claimed in claim 12, characterized in that an outside diameter of the first axial section (210) is larger than an inside diameter of the second axial section (220).

14. The windshield wiper device (100) as claimed in claim 13, characterized in that the second axial section (220) has a fastening element (240, 250) for the fastening of the wiper shaft bearing (110).

15. The windshield wiper device (100) as claimed in claim 14, characterized in that the fastening element comprises a plug-in element (250) for connection to a tubular plate (120) of the windshield wiper device (100).

16. The windshield wiper device (100) as claimed in claim 15, characterized in that the wiper shaft bearing (110) is produced as an injection molded component.
